(19) United States
(12) Patent Application Publication
(10) Pub. No.: US 2006/0201917 A1
(43) Pub. Date: Sep. 14, 2006

(54) Process for monitoring and controlling of thermal spray process

(75) Inventors: Mathias Bohmisch, Singen (DE); Cornelius Haas, Daisendorf (DE); Karl Holdik, Ulm (DE); Jurgen Steinwandel, Uhldingen-Muhlhofen (DE); Ansgar Zoller, Neu-Ulm (DE)

Correspondence Address: AKERMAN SENTERFITT, P.O. BOX 3188, WEST PALM BEACH, FL, 33402-3188, US

(73) Assignee: DaimlerChrysler AG, Stuttgart (DE)

(21) Appl. No.: 11/370,298

(22) Filed: Mar. 8, 2006

(30) Foreign Application Priority Data
Mar. 9, 2005 (DE) 102005010 754.045

(51) Int. Cl. B23K 9/00; B23K 9/02

(52) U.S. Cl. 219/121.47

(57) ABSTRACT

A process for monitoring the spray stream during thermal spraying of spray material, which contains at least two different materials A and B, by means infrared thermography, wherein the thermographic measured values are divided into at least two regions of the radiation intensity and these are assigned or associated to the respective image data for the at least two materials A and B as well as processes for controlling a thermal spray process with spray material multiple materials, wherein the material distribution of at least two materials A and B and their material specific average temperatures and/or radiation intensities within the spray stream are employed as normed values for the spray parameter carrier gas flow through, burner or flame power and/or material dosing.

### CROSS REFERENCE TO RELATED APPLICATION

This application claims the benefit of German Application No. DE 10 2005 010 754.0-45 filed Mar. 9, 2005.

### BACKGROUND OF THE INVENTION

1. Field of the Invention

The invention concerns an image-producing process for monitoring the spray stream during thermal spraying of a spray material containing at least two different materials A and B, by means of image-producing infrared thermography, in particular material combinations A-with-B of plastic or plastic mixtures with metal alloys, preferably for production of slide layers, friction layers or running-in layers, as well as processes for controlling the spray process by the evaluation of material-specific measured values in the spray stream and adaptation of the spray parameters.

Presently, conventional image-producing processes for controlling or regulating thermal spray processes based on optical processes in the ultraviolet (UV), visible (VIS), or near infrared (near IR) spectral region. A distinguishing of individual particle species, comprising for example different particle materials, is not undertaken.

2. Description of the Related Art

Such has been described in WO 01/73384 A1. For process control in thermal spray processes the particles in the spray stream are analyzed with respect to speed or speed distribution, as well as surface temperature, by means of image-producing procedures. This sensitive process data can then subsequently be employed for process control. With single-phase spray powders of sufficiently high particle temperatures, the established optical processes in the spectral region of approximately 250 to 1500 nn (UV to Near IR).are employed with use of rapid CCD or CMOS-cameras. Increasing demands in modern spray layers increasingly necessitate the production of composite layers with different materials. For this, multi-component spraying material is employed with success. Thus, for example, in the production of running-in layers a hard metallic component is combined with a soft, easily removed component of plastic. During spraying, thereby a polymer component is added to the main coating material. These polymer components exhibit a lower temperature in the spray stream, and the known measurement and control systems fail to measure these low temperatures.

In multi-component spray systems it is very desirable when the values of the components can be individually determined, since one value averaged for all components is only insufficiently or partially, if at all, suitable for process control.

From DE 10025161 A1 a process for production of a corrosion and friction resistant layer on the basis of Fe₂O₃ by thermal spraying is known, wherein the application of layer upon a substrate material is monitored by an on-line control and regulating system. The on-line control occurs by means of an infrared thermal graphic camera directed upon the spray stream, a laser Doppler anemometer and a laser Doppler laser, as well as a high speed pyrometer. The process is designed to determine the particle speed in the spray flame by the laser Doppler anemometer system and the particle temperature in the spray flame by means of the high speed pyrometer or by means of infrared thermography. DE 19857737 A1 discloses the production of composite layers of magnetite and further metallic or ceramic materials according to the same on-line monitored process.

A disadvantage of the above-discussed process is the complex measurement equipment of various partial systems. It is also not possible to obtain an individual analysis or inspection of the different materials in the spray stream.

### SUMMARY OF THE INVENTION

It is thus the task of the invention to provide a process which makes possible, for a thermal spray processes with a multi-component spray material, a component-specific or, as the case may be, material-specific measurement of the particle characteristics in the spray stream, and an on-line inspection or control of the spray stream with a simple measuring device.

The task is inventively solved by a process for monitoring the spray stream with thermal spraying of spray material which contains at least two different materials A and B, by means of image providing infrared thermography, as well as a process for controlling a thermal spray process with spray material comprised of multiple materials.

In a first aspect of the invention there is provided a process for monitoring the spray stream during thermal spraying of spray material, which contains at least two different materials A and B, by means image-providing infrared thermography, in which the thermographic measured values are divided into at least two ranges or regions of radiation intensity, and these are allocated to the respective image data for the at least two materials A and B.

Therein it is essential that the thermographic measurement data is analyzed and divided into at least two data sets, wherein the respective data sets are associated with the different materials A and B. Thereby the two components of the spray stream, as determined by the at least two different materials A and B, can be represented material-specifically. The components can be represented separately or together graphically.

In comparison to known processes this represents a substantial advantage since the individual components can now be separately observed.

A further advantage is that now also additional measured values associated with the physical sizes of the spray particles within the spray stream can be represented and evaluated material-specifically. These include for example temperature, particle size and particle speed.

The inventive process envisions the dividing of the thermographic measured values into multiple intensity regions. Thereafter, the ranges or regions are associated with the individual materials (A or B). By the image-providing measurement method it is possible to detect the single particles individually and, for the single particles, to measure radiation or stream intensities or stream intensity distributions. Depending upon radiation intensity or distribution a material classification occurs. The association is based thereupon, that the materials exhibit in part different temperatures and clearly different emissions. Therewith the materials display radiation intensities in the spray flame clearly distinguishing from each other, in particular radiation intensity distributions.

The process will naturally provide particularly good results when the materials differ from each other in their emissivity and in particular in their temperature within the spray stream. The different temperatures are evoked for example by the differential energy absorption of the individual materials in the spray stream, as well as their energy emission in the spray stream. Clear differences can be seen for example in the material pairings plastic/metal or metal/ceramic.

If for example only two materials A and B are employed in the spray material, it can be sufficient to determine a threshold value of the intensity, below which the particles of material A and above which the particles of material B can be classified.

For determining the suited intensity ranges the total distribution of the intensity, that means in principle overall relevant image points, can be statistically evaluated. Therein the overlapping intensity variations of the individual materials, as well as the background radiation, are separated from each other by computer methods. The intensity regions lie then graphically underneath the individual distribution curves.

Preferably the ranges of radiation intensity are so selected, that within one region respectively at least one maximum of the intensity distribution occurs. As a rule the maximum or the maxima can be comparatively reliably determined by statistical methods, so that a good reliability and reproducibility of the material specific evaluation is pre-ordained.

It is in the nature of the inventive measurement process, that the boundaries of the regions are not material-specific absolute values. Depending upon the type of the spray material or, for example, the introduced spray energy, the intensity distribution and also the intensity regions selected can be shifted depending upon the purpose. Thus, in a preferred embodiment, the intensity regions in the case of changing spray parameters during the spray process are dynamically determined and adapted insofar as necessary. For example, the intensity regions are shifted to higher values in the case of increasing the energy of the spray temperature.

Frequently it is however useful to determine the regions of the radiation intensity of the respective materials (A or B) by independent measurement for the selected spray element at different operating conditions and with the respective material mixtures. It is in particular then to be preferred, when the materials have similar physical characteristics, or one of the components is present in only a comparatively small proportion, or a number of different components is present.

In accordance with the invention, for making the thermographic measurement values, infrared cameras are particularly suited, and in particular high speed infrared cameras.

The illumination of the infrared camera is preferably so high, that the illumination time for the thermographic photos is less than 200 μs. According to the process it is not necessary that the individual particles be imaged sharply or, as the case may be, frozen in resolution. Depending upon illumination time the particles could be points or dashes, in certain cases lines. The evaluation algorithm can be adapted to the corresponding representation. Preferable illumination times lie in the range of from 10 to 100 μs. In the particle speeds conventional in the spray stream, using these time dashes are what is primarily imaged.

The spectral range of the camera lies preferably at 1 to 15 μm, particularly preferably at 3 to 5 or, in certain cases 8-12 μm. This region is particularly well suited for particle temperatures below approximately 1000° K., in particular, when one of the components exhibits a particle temperature of below approximately 500° K.

Depending upon the selected materials of the spray material however other spectral ranges could be useful, which extend into the near infrared or into the visible light range. This is for example a case when one of the materials is a ceramic.

A further embodiment of the process envisions that for each of the regions of the radiation intensity a lower, central and/or maximal radiation temperature is determined. Correspondingly each of the components can be associated or classified to a temperature value which is characteristic in the spray stream. Particularly preferred is when the central temperature is determined for each of the materials. This central temperature can be correlated with pre-determined critical boundaries or limitations such as, for example, decomposition or evaporation temperatures.

In a further embodiment of the invention it is provided that, by an association of the various intensity regions or the lower, central and/or maximal radiation temperature to the at least two materials A and B, a conversion of the thermorgraph image into a material distribution image occurs.

For a further evaluation it can be useful to limit the representation to a distribution image of the respective maximal radiation temperatures. Whereby the evaluation algorithms are simplified. In particular in the evaluation of the particle speeds were the material distribution within the spray flame good results can likewise be obtained with these reduced data sets.

In a further advantageous embodiment of the invention complex material mixtures of the spray material are employed. The materials A and/or B are comprised therein respectively of mixtures of materials of chemically related substance classes. These include for example thermoplastics, duroplastics, light metal alloys, steels, intermetallic compounds, oxide ceramics, metal carbide ceramics or carbon ceramics.

The inventive preferred material combinations include those of which the melting points differ by at least 150° C., particularly preferably 200° C., from each other. It was discovered that the separation distinctness of the measurement process improves with increasing melt temperature difference.

The particularly preferred material combinations A with B include plastics or plastic mixtures, metal alloys; in particular polyester, polyamides, polyolefins, polyethers or fluoridated polyolefins with aluminum alloys, Cu-alloys, Al-bronzes, Cu-bronze or brass.

Further interesting material combinations include metal alloys, in particular light metal alloys, cast iron or steel with ceramics, in particular carbides, nitrides or oxide ceramics.

In a further inventive evaluation process the particle speed is determined in the spray stream. In very short illumination times of the camera this can also occur by comparison of multiple sequential thermographic images. Particularly preferred is when, with the high particle speeds, measurements are made with longer illumination times and the particle speeds are determined by evaluation of the length of the dashes or lines which form the images of the particles respectively within an image.

As intermediate or final result, preferably distribution images of the particle speeds and/or speed distribution is determined. However these results can provide information regarding the turbulence and homogeneity of the spray flame.

In accordance with the invention that is proposed to determine a material specific representation of the particle speeds or in material specific particle speed distribution. Thereby early recognition also becomes possible in the flame occurring in homogeneities of the demixing.

The inventive process can be employed in particular in the following thermal spray processes: atmosphereic plasma spraying (APS), autogenic flame spraying, high speed flame spraying (HVOF), arc wire spraying (LDS) or high power plasma spraying (HPPS).

A further aspect of the invention concerns a process for controlling a thermal spray process with spray material, which is comprised of multiple materials. In accordance with the invention it is provided that the material distribution of at least two materials A and B, and their material specific average temperatures within the spray stream, are employed as normed sizes for the spray parameters: carrier gas flow or carrier gas stream, flame power and/or material dosage or proportioning.

The combination of the information of material distribution and temperature distribution provides a very good image of the quality of the spray flame. Inhomogeneities of the flame can be remedied by follow-up control of the carrier stream or by changing of the material dosing, in particular also only by a supplemented material.

The material specific temperature distribution is of significance in particular with respect to the maintaining of critical boundary values, such as for example decomposition temperatures of pyrolytic material, melting temperature of metal alloys or vaporization temperatures of alloy components. The temperature control can occur by changing the flame power and/or the material dosing.

Particularly preferred is when the controlling of the spray parameters is so adjusted, that the average spray power or the average temperature of one component A is automatically maintained within a narrow region within the critical threshold or boundary values. If a plastic is employed as the component A, then the critical threshold value is functionally or appropriately the decomposition temperature.

At least the material distribution or the material specific temperature distribution or, as the case may be, radiation intensity distribution are preferably determined according to the already described process.

The preferred uses of the described process include thermal spraying of slide material layers, friction layers or running-in layers or coatings, which are formed of multi-phase materials or, as the case may be, composite materials. Particularly in the series production of components with the mentioned composite layers of at least two different materials, high demands are placed upon the process monitoring, and very rapid-acting quality-ensuring control mechanisms are necessary.

Particularly preferably, the mentioned processes can be employed for example in the production of running-in coatings of thermoplastic and aluminum alloys.

By way of example, the results for the arc wire spray process with the two components AlSi-alloy and polyester are shown in FIG. 1 through FIG. 4 on the basis of camera images and evaluated photos.

### BRIEF DESCRIPTION OF THE DRAWINGS

There is shown in:

FIG. 1. a spray stream after leaving the spray nozzle with background illumination 1 and individual particles as dashes 2,

FIG. 2. the same section of the spray stream following subtraction of the background radiation and individual particles as dashes 2,

FIG. 3. the same section of the spray stream with representation of the AlSi particles 3,

FIG. 4. the same section of the spray stream with representation of the polyester particles 3.

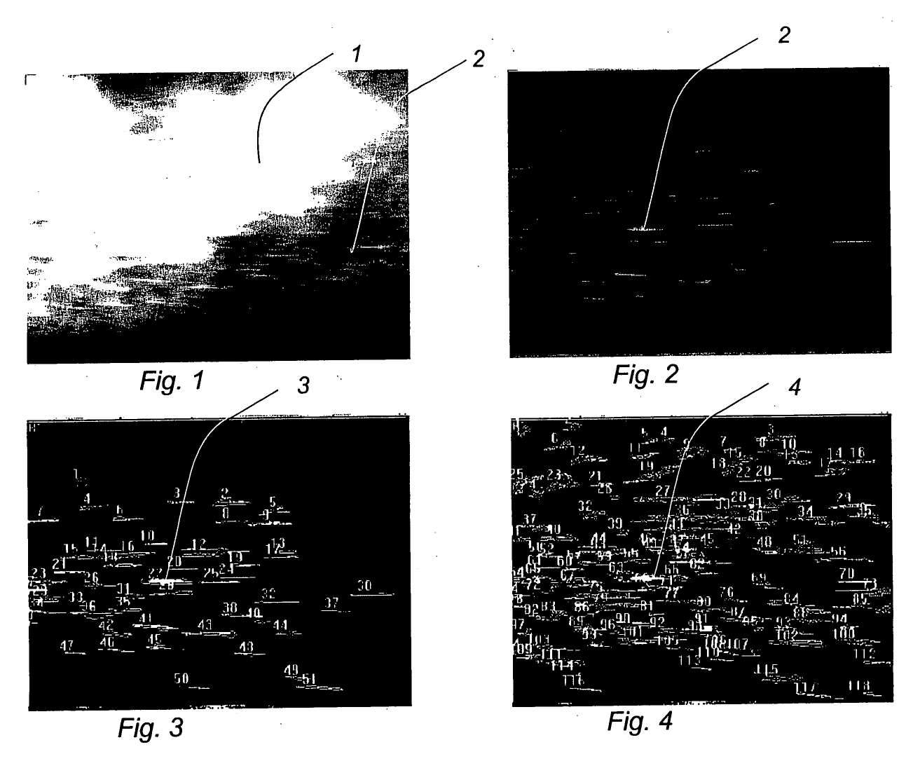

### DETAILED DESCRIPTION OF THE INVENTION

The background radiation of the spray stream 1, which is comprised essentially of the plasma flame, is determined and subtracted from the image, so that a substantial improvement of the useful measuring information is achieved. Now also in the central area of the spray flame individual particles 2 are clearly recognizable.

In FIG. 2 and FIG. 3 it is clearly recognizable, that the individual particles can be individually resolved and classified to the individual materials. The represented dash positions or orientations allow a determination of the particle speed of the individual particles.

1. A process for monitoring a spray stream during thermal spraying of spray material, which contains at least two different materials A and B, by means of image-producing infrared thermography, comprising:
dividing the thermographic measured values into at least two regions of radiation intensity and
assigning these to the respective image data for the at least two materials A and B.

2. A process according to claim 1, wherein the regions of the radiation intensity of the respective materials A or B are determined by independent measurements of the respective pure materials A or B.

3. A process according to claim 1, wherein the ranges of the radiation intensity are dynamically determined and established during changing spray parameters during the spray process.

4. A process according to claim 1, wherein the thermographic measured values are obtained by one or more high speed infrared cameras.

5. A process according to claim 4, wherein the exposure time of the thermographic photographs lies at 10 to 100 μs.

6. A process according to claim 1 wherein in each of the regions of the radiation intensity respectively at least one maximum of the intensity distribution occurs.

7. A process according to claim 1, wherein for each of the regions of radiation intensity at least one of a lower, central and maximal radiation temperature is determined.

8. A process according to claim 1, wherein by assignment of the different intensity ranges, or the lower, central and/or maximal radiation temperature, to the at least two materials A and B, a conversion of the thermographic into a material distribution image occurs.

9. A process according to claim 1, wherein at least one of the materials A and B are selected respectively from mixtures of materials of chemically related classes of substances.

10. A process according to claim 9, wherein the melting point of the materials A and B differ from each other by at least 150° C.

11. A process according to claim 1, wherein the material A is plastic or plastics and the material B is metal or metal alloys.

12. A process according to claim 1, wherein by comparison of multiple sequential thermograph images or evaluation of individual thermographic images a determination of at least one of the particle speed and speed distribution occurs.

13. A process according to claim 12, wherein the determination and representation of the particle speed or distribution occurs material-specific.

14. A process according to claim 1, wherein the thermal spray process is atmospheric plasma spraying (APS), autogenic flame spraying, high speed flame spraying (HVOF), arc wire spraying (LDS) or high power plasma spraying (HPPS).

15. A process for controlling a thermal spray process with spray material with multiple materials, wherein the material distribution of at least two materials A and B and their material specific average radiation intensity and/or radiation temperature within the spray stream are employed as normed values for the spray parameters: carrier gas flow-through, burner power and/or material dosing.

16. A process according to claim 15, wherein the spray parameters are so regulated, that the average temperature of one component A is maintained below a predetermined critical threshold value.

17. A process according to one of claims 15, wherein the determination of at least one of the material distribution, the material specific temperature distribution or average radiation intensity occurs in accordance with a process for monitoring a spray stream during thermal spraying of spray material by means of image-producing infrared thermography comprising:
dividing the thermographic measured values into at least two regions of radiation intensity and
assigning these to the respective image data for the at least two materials A and B.

18. A process for production of thermal sprayed slide layers, friction layers or running-in layers, formed by composites of at least two different materials A and B with a process for monitoring a spray stream during thermal spraying of spray material by means of image-producing infrared thermography, comprising:
dividing the thermographic measured values into at least two regions of radiation intensity and
assigning these to the respective image data for the at least two materials A and B.

19. A process according to claim 18 wherein said running-in coatings are comprised of plastic and aluminum alloy.
